(19) United States
(12) Patent Application Publication
(10) Pub. No.: US 2025/0052318 A1
(43) Pub. Date: Feb. 13, 2025

(54) GEAR MECHANISM AND ROBOT

(71) Applicant: FANUC CORPORATION, Minamitsuru-gun, Yamanashi (JP)

(72) Inventor: Jingting CHEN, Yamanashi (JP)

(73) Assignee: FANUC CORPORATION, Minamitsuru-gun, Yamanashi (JP)

(21) Appl. No.: 18/718,938

(22) PCT Filed: Jan. 12, 2022
(86) PCT No.: PCT/JP2022/000653

§ 371 Date: Jun. 12, 2024

(51) Int. Cl. F16H 57/12; B25J 9/10; F16H 1/14; F16H 57/023

(52) U.S. Cl. CPC F16H 57/12; F16H 1/145; F16H 57/023; B25J 9/102; F16H 2057/0235; F16H 2057/125

(57) ABSTRACT

A gear mechanism including a rotatably supported first gear, a second gear meshed with the first gear, the second gear rotatably supported around a second axis line and having a smaller conical angle than the first gear, a holder which supports the second gear in a rotatable manner with a bearing, and a shim for the second gear which is placed at a position between the holder and a gearbox and which can adjust a position of the second gear in the direction along the second axis line. The second gear shim includes a through hole in which the holder is located so that the holder penetrates the second gear shim, and a path which extends from an outer circumference edge of the second gear shim to the through hole, where the path allows the holder to pass in a direction crossing the second axis line.

### TECHNICAL FIELD

The present disclosure relates to a gear mechanism and a robot.

### BACKGROUND

Conventionally, shims for adjusting positions of a ring gear and a pinion gear of a hypoid gear set in their axis directions to adjust a backlash amount between the ring gear and the pinion gear is used in a gear mechanism of a robot (See Japanese Unexamined Patent Application, Publication No. 2018-1277, for example).

It is necessary to set the shims to have optimal thicknesses in order to obtain the optimal backlash amount between the ring gear and the pinion gear. Preferably, the shim is placed over the entire circumference of the gear around the axis line in order to prevent inclination of the gear, especially the pinion gear, which tends to be long, and it is general to employ a shim having a through hole for inserting a shaft of the gear.

### SUMMARY

An aspect of the present disclosure is a gear mechanism including: a gearbox; a first gear accommodated in the gearbox and rotatably supported around a first axis line; a second gear accommodated in the gearbox and meshed with the first gear, the second gear rotatably supported around a second axis line extending along a flat surface crossing the first axis line and having a smaller conical angle than the first gear; a holder which is attached to the gearbox, which is removable in a direction along the second axis line, and which supports the second gear in a rotatable manner by means of a bearing; and a second gear shim which is placed at a position between the holder and the gearbox and which can adjust a position of the second gear in the direction along the second axis line, wherein the second gear shim comprises: a through hole in which the holder is located in a state where the holder penetrates the second gear shim; and a path which extends from an outer circumference edge of the second gear shim to the through hole, wherein the path allows the holder to pass in a direction crossing the second axis line between an outside of the second gear shim and an inside of the through hole.

### BRIEF DESCRIPTION OF DRAWINGS

FIG. 1 is a perspective view of a robot according to one embodiment of the present disclosure.

FIG. 2 is a sectional view in a vertical direction of the robot of FIG. 1.

FIG. 3 is a longitudinal sectional view of the gear mechanism according to one embodiment of the present disclosure provided in the robot of FIG. 1, which is seen from a direction orthogonal to a second axis.

FIG. 4 is a sectional view in the vertical direction of the gear mechanism of FIG. 3, which is seen from the direction along the second axis.

FIG. 5 is a partial perspective view which explains attachment of a pinion gear, a holder, and a shim provided in the gear mechanism of FIG. 3.

FIG. 6 is a perspective view showing one example of a shim on a side of the ring gear provided in the gear mechanism of FIG. 3.

FIG. 7 is a flowchart explaining an adjustment operation of the shim in the gear mechanism of FIG. 3.

FIG. 8 is a perspective view showing a modified example of the shim on a side of the pinion gear of FIG. 5.

FIG. 9 is a perspective view showing another modified example of the shim on a side of the pinion gear of FIG. 5.

FIG. 10 is a perspective view showing another modified example of the shim on a side of the pinion gear of FIG. 5.

### DESCRIPTION OF EMBODIMENTS

For example, in order to adjust thickness of a shim inserted between a gear and a bearing which rotatably supports the gear, it is required to remove an assembly of the gear and the bearing from a structure portion and separate the gear and the bearing. Then, the shim is removed from the shaft of the separated gear, or the shim is added to the shaft, and then the assembly of the gear and the bearing which are reassembled is attached to the structure portion to confirm tooth contact. This operation needs to be executed repeatedly, and this attachment and detachment process requires a large amount of time.

Also, meshing between the gears is released when the assembly of the gear and the bearing is removed from the structure portion. However, since the meshing phase between the gears becomes different, there is a case where the meshing of the gears needs to be adjusted from the beginning once the meshing is released. For that reason, it is desired to minimize the assembly operation of the gear and the bearing and the like, and to adjust the backlash amount without releasing the meshing of the gears.

A gear mechanism 1 and a robot 100 according to one embodiment of the present disclosure will be described below with reference to the accompanying drawings.

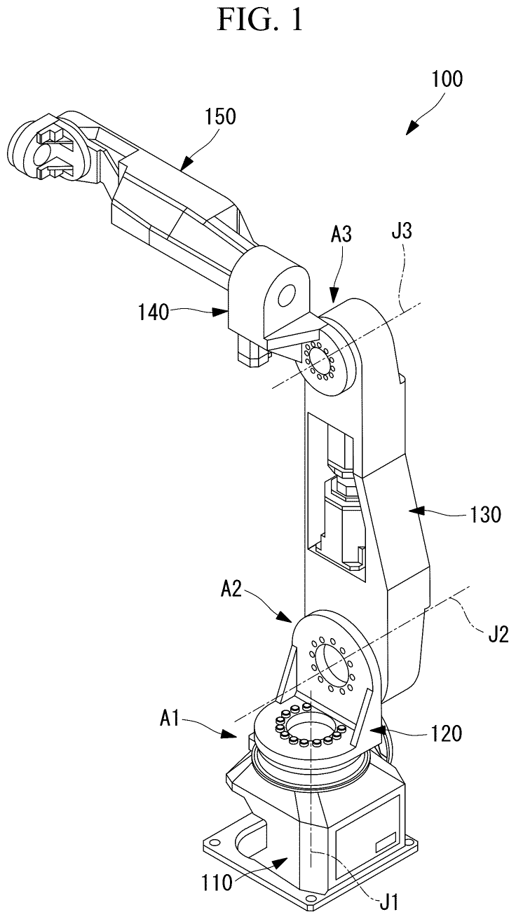

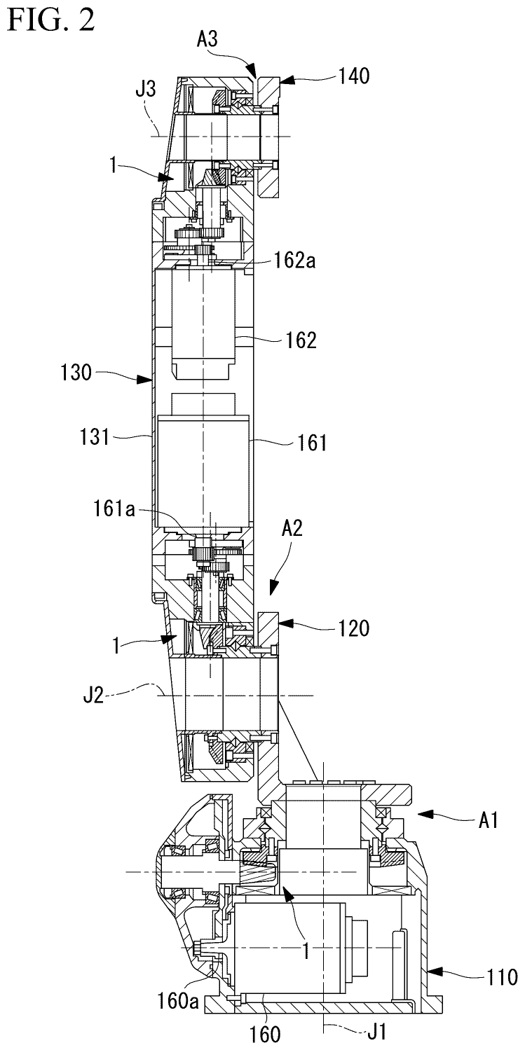

As shown in FIGS. 1 and 2, the robot 100 according to this embodiment is a six-axis articulated robot, and the robot 100 includes a base 110 which is placed on an installation surface such as a floor and the like, and a turning drum 120 which is rotatable around a first axis J1 with respect to the base 110.

Also, the robot 100 includes a first arm 130 rotatable with respect to the turning drum 120 around a second axis J2 which is placed in a flat surface orthogonal to the first axis J1, and a second arm 140 rotatable with respect to the first arm 130 around a third axis J3 which is parallel to the second axis J2. Further, the robot 100 includes a three-axis wrist unit 150 which is attached to a distal end of the second arm 140.

A gear mechanism 1 is provided in each of a first joint A1 for rotating the turning drum 120 around the first axis J1 with respect to the base 110, a second joint A2 for rotating the first arm 130 around the second axis J2 with respect to the turning drum 120, and a third joint A3 for rotating the second arm 140 around the third axis J3 with respect to the first arm 130. The first to the third joints A1, A2, A3 include motors 160, 161, 162, respectively, and the gear mechanism 1 reduces rotation speed of shafts 160a, 161a, 162a of the motors 160, 161, 162 to transmit them.

The gear mechanism 1 according to the present embodiment will be described below by exemplifying the second joint A2 for rotating the first arm 130 around the second axis (a first axis line) J2 with respect to the turning drum 120.

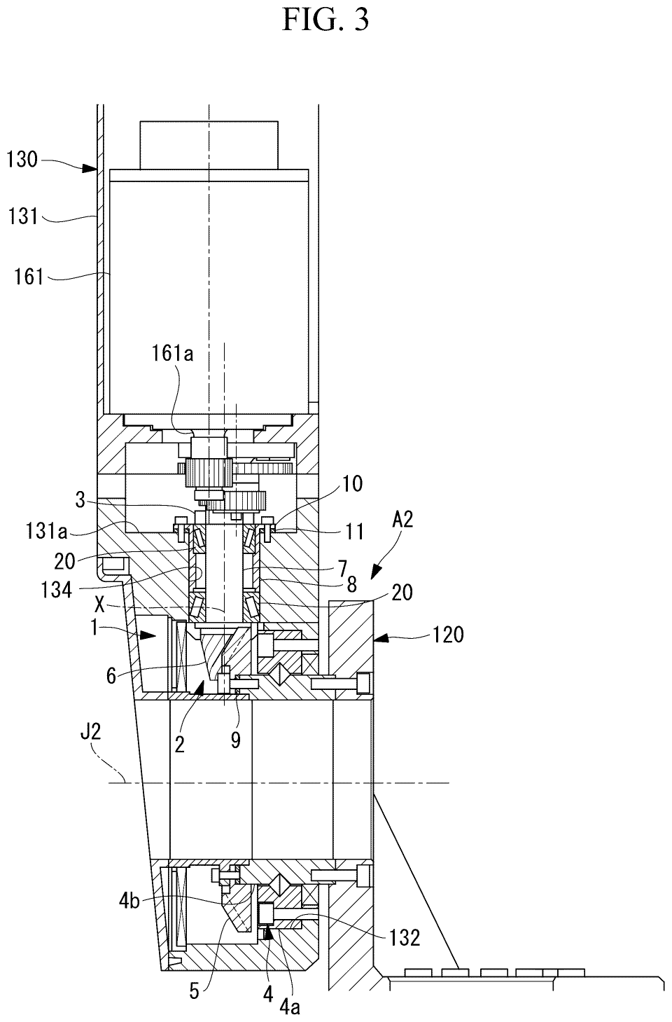

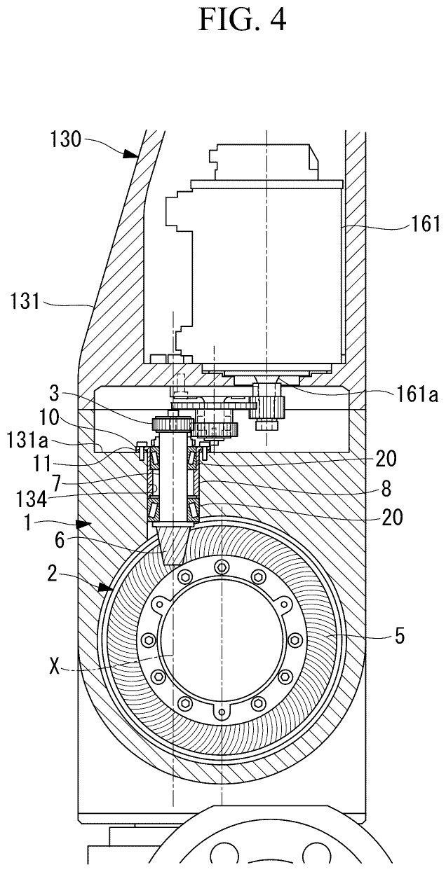

As shown in FIGS. 3 and 4, the gear mechanism 1 according to the present embodiment is accommodated in a housing (a gearbox) of the first arm 130 to which the motor 161 is detachably fixed.

The gear mechanism 1 includes a hypoid gear (hypoid spiral bevel gear) set 2 and more than one pair of parallel shaft gears 3 which are located at a position between the hypoid gear set 2 and the motor 161.

The hypoid gear set 2 includes a ring gear (a first gear) 5 supported by a bearing 4 so as to be rotatable around the second axis J2 with respect to a housing 131, and a pinion gear (a second gear) 6 which is meshed with the ring gear 5. The ring gear 5 is fixed to the turning drum 120.

The pinion gear 6 has a conical angle which is sufficiently smaller than the ring gear 5, and is provided on the other end of an elongated shaft 7, one end of which is provided with the parallel gear 3.

The pinion gear 6 is provided so as to be rotatable around an axis line (a second axis line) X which is located along a flat surface orthogonal to the second axis J2.

As shown in FIG. 3, the ring gear 5 is fixed to an inner ring 4b of the bearing 4 whose outer ring 4a is fit into a mating hole 132 provided in the housing 131 along the second axis J2 so that the ring gear 5 is supported by the housing 131 so as to be rotatable around the second axis J2.

Also, as shown in FIGS. 3 and 4, the gear mechanism 1 includes a holder 8 for supporting the pinion gear 6 by means of the bearing 20 so that the pinion gear 6 becomes rotatable around the axis line X. The holder 8 is provided in the housing 131 by fitting its outer surface of a cylindrical shape into a mating hole 134 which is provided in the housing 131 along the axis line X.

Also, the gear mechanism 1 includes a shim (a first gear shim) 9 made of a thin metal plate inserted between the ring gear 5 and the end surface of the inner ring 4b of the bearing 4 to which the ring gear 5 is fixed in a direction along the second axis J2. Accordingly, the ring gear 5 is attached to the housing 131 so that its position is adjustable in the direction along the second axis J2 by adjusting thickness dimension of the shim 9.

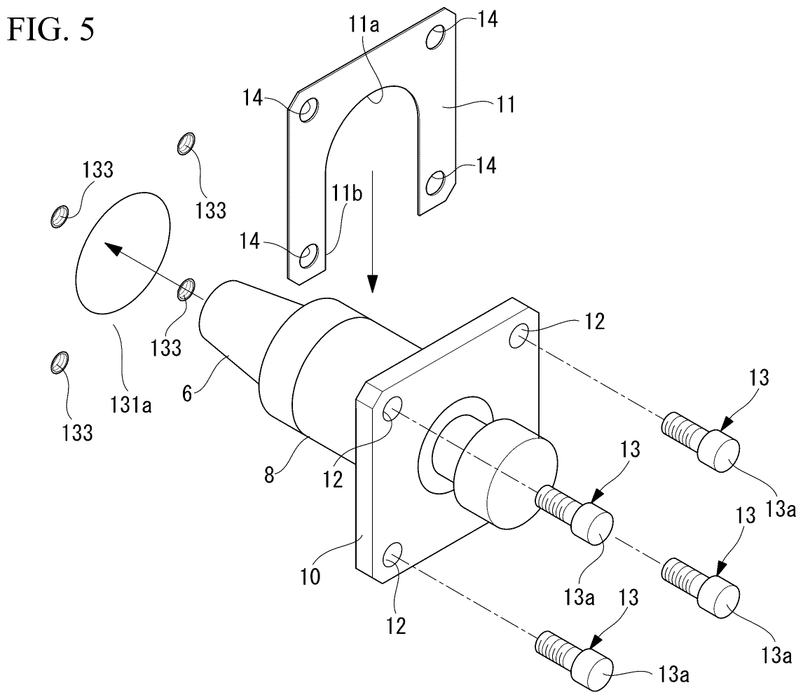

Further, as shown in FIG. 5, the gear mechanism 1 includes a shim (a second gear shim) 11 made of a thin metal plate inserted between a flange 10 which is provided in the holder 8 and which protrudes in the radial outside direction, and an locating surface 131a of the housing 131 which abuts on the flange 10 in the direction along the axis line X. Accordingly, the pinion gear 6 is attached to the housing 131 so that the position can be adjustable in the direction along the axis line X by adjusting the thickness dimension of the shim 11.

The outer shape of the flange 10 has a square shape when it is seen from a direction along a center axis of the holder 8, and the flange 10 has penetrating holes 12 at four corners of the square shape at an equal space in a circumferential direction around the center axis of the holder 8. An inner diameter of the penetrating hole 12 is formed to be smaller than an outer diameter of a head portion 13a of a bolt (a fixing bolt) 13 which passes through the penetrating hole 12.

Moreover, in the locating surface 131a of the housing 131, a plurality of screw holes 133 is provided in a phase corresponding to positions of the screw holes 12 of the flange 10. The holder 8 can be fixed to the housing 131 by fastening the bolts 13 which pass through the penetrating holes 12 of the flange 10 into the screw holes 133 of the locating surface 131a.

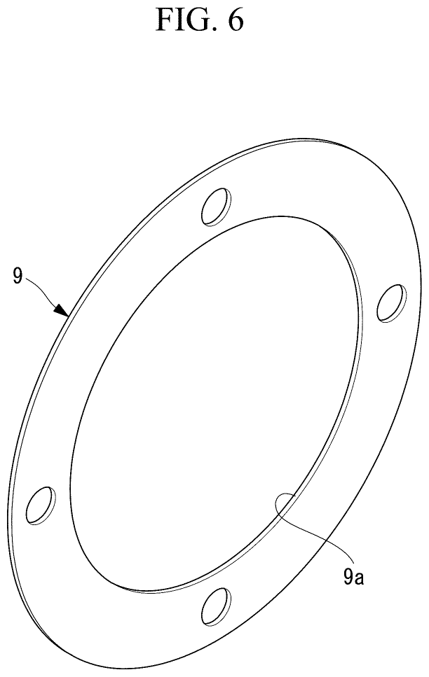

In this embodiment, as shown in FIG. 6, the shim 9 on the side of the ring gear 5 has a through hole 9a for inserting a shaft portion of the ring gear 5, and the shim 9 is formed in an annular shape and comes into close contact with the end surface of the inner ring 4b of the bearing 4 in a direction along the second axis J2. The thickness dimension of the shim 9 on the side of the ring gear 5 is set based on measured dimensional values of all components which affect the position of the ring gear 5 in the direction along the second axis J2.

In this embodiment, the components are the housing 131, the bearing 4, and the ring gear 5, for example. The thickness dimension of the shim 9 on the side of the ring gear 5 is pre-set so that the ring gear 5 is placed at a position within a predetermined area with reference to a designed position based on the measured dimensional values of all components in the direction along the second axis J2. That is, since the shim 9 of the pre-set thickness dimension is inserted between the ring gear 5 and the inner ring 4b of the bearing 4, it is possible to have an optimal backlash amount only by adjusting the shim 11 on the side of the pinion gear 6.

Also, in this embodiment, the outer shape of the shim 11 on the side of the pinion gear 6 has a square shape which is almost the same as or similar to that of the flange 10, and the shim 11 has a through hole 11a whose inner diameter is slightly larger than the outer diameter of the holder 8 at the center of the shim 11, and a path 11b extending from one side of the outer circumference edge to the through hole 11a. The path 11b has a width dimension (a constant width) that is almost the same as or similar to the diameter of the through hole 11a. By this, the shim 11 is formed in a U-shape as a whole.

Also, the penetrating holes 14, which are placed in the same phase as the through holes 12 of the flange 10 and which have almost the same inner diameter as the through holes 12, are provided in a vicinity of four corner portions of the outer shape of the shim 11.

Function of the gear mechanism 1 and the robot 100 according to this embodiment as described above will be described below.

In this embodiment, the position of the ring gear 5 in the direction along the second axis J2 can be adjusted by means of the shim 9 which is placed at a position between the ring gear 5 and the end surface of the bearing 4. By this, it is possible to place the ring gear 5 accurately even when the component such as the housing 131, the bearing 4, the ring gear 5, and the like which affect the position of the ring gear 5 in the direction along the second axis J2 are different in sizes.

Since the conical angle of the ring gear 5 is sufficiently larger than that of the pinion gear 6, the thickness of the shim 9 on the side of the ring gear 5 directly affects the backlash amount between the ring gear 5 and the pinion gear 6 more than the shim 11 on the side of the pinion gear 6. On the other hand, the thickness of the shim 11 on the side of the pinion gear 6 affects moderately on the backlash amount between the ring gear 5 and the pinon gear 6 compared with the shim 9 on the side of the ring gear 5. Accordingly, fine tuning of the backlash amount is possible by adjusting the thickness dimension of the shim 11 on the side of the pinion gear 6.

And, this embodiment sets a position range of the ring gear 5 capable of achieving the optimal backlash amount between the ring gear 5 and the pinion gear 6 within the position adjustment range of the pinion gear 6 by means of the shim 11 on the side of the pinion gear 6. Accordingly, once the shim 9 having the optimal thickness is inserted between the inner ring 4b of the bearing 4 and the ring gear 5, it becomes possible to achieve the optimal backlash amount only by adjusting the position of the pinion gear 6 without changing the shim 9.

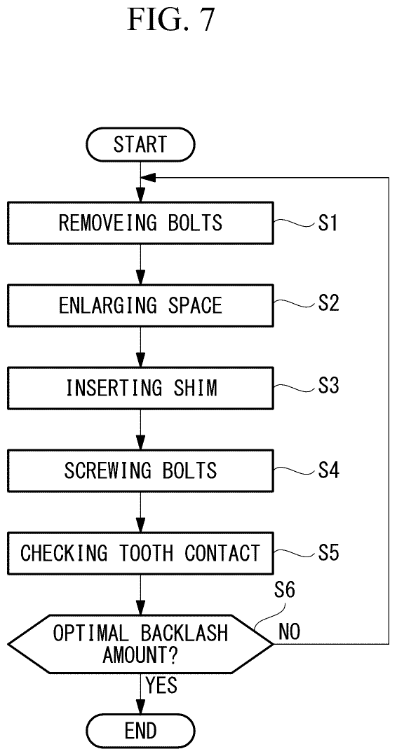

Further, in this embodiment, the thickness dimension of the shim 11 on the side of the pinion gear 6 is adjusted in the following steps as shown in FIG. 7.

Firstly, all of the four bolts 13 which fix the holder 8 to the housing 131 are removed (step S1). Then, a space between the flange 10 of the holder 8 and the locating surface 131a of the housing 131 is enlarged by slightly moving the holder 8 in the direction along the second axis J2 (step S2).

Further, the shim 11 is removed from the enlarged space in the radially outward direction of the holder 8, or an additional shim 11 is inserted into the space from the radially outward direction of the holder 8 (step S3). Since the shim 11 is provided with the path 11b extending from one side of the shim 11 to the through hole 11a, the holder 8 can be inserted in and removed from the through hole 11a via the path 11b by moving the shim 11 in the radial direction of the holder 8.

After that, the four bolts 13 are screwed to screw holes 133 of the housing 131 via the four through holes 12 of the flange 10 (step S4). By this, more than one shim 11 is inserted between the flange 10 and the locating surface 131a of the housing 131 in the thickness direction. And, in this state, tooth contact is checked by rotating each of the engaged ring gear 5 and the pinion gear 6 around the second axis J2 and the axis line X (step S5). Whether the optimal backlash amount is obtained or not is checked (step S6), and when the optimal backlash amount is not obtained, the operation is repeatedly executed from step S1 to adjust the backlash amount. Also, the operation will be terminated when the optimal backlash amount is obtained.

With the gear mechanism 1 according to this embodiment as described above, it is not necessary to remove the holder 8 and the pinion gear 6 from the mating hole 134 of the housing 131 when adjusting the thickness dimension of the shim 11 on the side of the pinion gear 6, which is advantageous. That is, the shim 11 can be removed or inserted just by slightly enlarging the space between the locating surface 131a of the housing 131 and the flange 10 of the holder 8, and therefore, it is not necessary to release the engagement of the pinion gear 6 and the ring gear 5, which is advantageous.

As a result, even if there is a variation in the engagement phase of the ring gear 5 and the pinion gear 6, it is not necessary to adjust the engagement from the first step. Accordingly, it is possible to adjust the backlash amount promptly by minimizing the assembly work of the pinion gear 6, the bearing 4, and the like and simplifying the adjustment operation.

Also, in this embodiment, a penetrating hole 14 for inserting the bolt 13 is provided in the shim 11 on the side of the pinion gear 6, and the size of the penetrating hole 14 is smaller than the outer diameter of the head portion 13a of the bolt 13. By this, it is possible to insert the shim 11 certainly between the flange 10 and the locating surface 131a within the area of each of the head portions 13a of the four bolts 13. As a result, the distance between the locating surface 131a and the flange 10 can be set precisely so that the distance is equivalent to the thickness dimension of the shim 11 while preventing elastic deformation of the flange 10 caused by fastening the bolts 13.

Also, in this embodiment, the gear mechanism 1 which is provided in the second joint A2 located between the turning drum 120 and the first arm 130 rotatable around the second axis J2 with respect to the turning drum 120 is described as an example. However, it is not limited hereto, and this composition may be applied to a gear mechanism 1 of the first joint A1, the third joint A3, or the wrist unit 150.

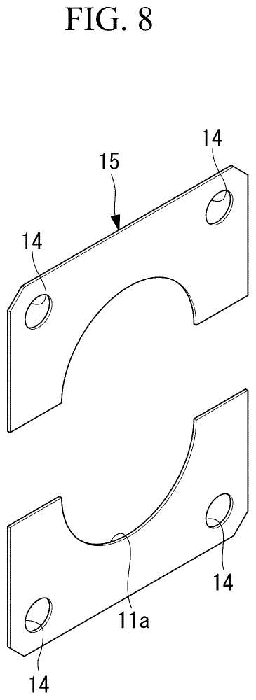

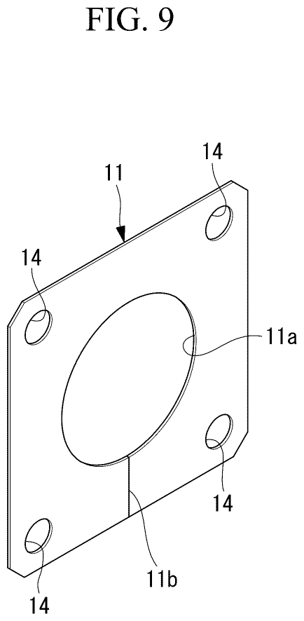

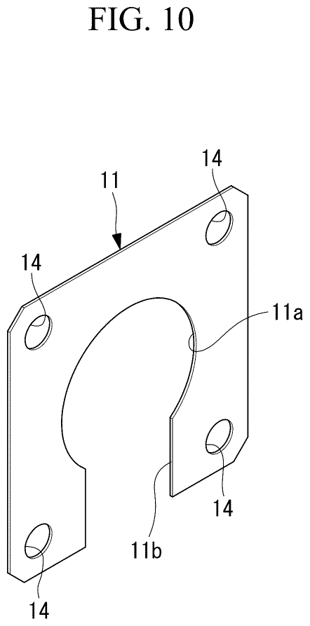

Moreover, in this embodiment, the U-shaped shim 11 which is shown in FIG. 5 is employed as the shim 11 on the side of the pinion gear 6, however, instead of this type of shim, it is possible to employ a dividable type shim 15 which is shown in FIG. 8. Further, as shown in FIG. 9, it may be possible to employ a shim 11 with a path formed by a cut, or a shim 11 having a path 11b which is narrower than the diameter of the through hole 11a, which is shown in FIG. 10.

As shown in FIG. 5, with the shim 11 having the path 11b with the same width as the diameter of the through hole 11a, the shim 11 can be inserted into and removed from a narrower space without bending the shim 11 in the thickness direction when inserting into and removing from the holder 8, which is preferable.

Also, in this embodiment, the penetrating hole 14 for inserting the bolts 13 into the shim 11 is provided to prevent deformation of the flange 10, however, it is not necessary to place the shim 11 around the bolt 13 when rigidity of the flange 10 can be ensured. By this, the shim 11 is replaceable just by loosening the bolts 13 without removing the bolts 13.

Also, in this embodiment, the gear mechanism 1 having the hypoid gear set 2 is described as the example, however, instead of this, any gear set as long as the gears have different conical angles can be applied to the gear mechanism 1, such as a bevel gear and the like. Also, this embodiment describes the case where the axis line X of the pinion gear 6 is placed within a flat surface orthogonal to the second axis J2 of the ring gear 5, however it is not limited thereto, and the second axis line of the second gear may be placed within the flat surface crossing the first axis line of the first gear.

Moreover, in this embodiment, it is preferable that the shim 9 on the side of the ring gear 5 is set to have a thickness dimension so that the ring gear 5 is placed at a position distant from the axis line X of the pinion gear 6 with respect to a designed position. The shim 11 on the side of the pinion gear 6 at the initial assembly is set to have thickness equivalent to a designed position in a state where at least one shim 11 is inserted so that the position of the pinion gear 6 in the axis line X can be adjusted in the both directions relative to the designed position. In this case, since the ring gear 5 is positioned in the direction distant from the axis line X of the pinion gear 6 relative to the designed position, the thickness dimension of the shim 11 on the side of the pinion gear 6 for obtaining the optimal backlash amount is reduced.

That is, when the thickness of the shim 11 is increased, the pinion gear 6 is displaced in a direction in which the pinion gear 6 is inclined due to the elasticity of the shim 11. And therefore, this configuration is advantageous in that the optimal backlash amount can be obtained by adjusting the thickness of the shim 11 to be smaller to prevent the pinion gear 6 from inclining.

Further, this embodiment exemplifies the six-axis articulated robot, however, it is not limited hereto, and any types of robot can be used.

1. A gear mechanism, comprising:
a first gear accommodated in a gearbox and rotatably supported around a first axis line;
a second gear accommodated in the gearbox and meshed with the first gear, the second gear rotatably supported around a second axis line extending along a flat surface crossing the first axis line and having a smaller conical angle than the first gear;
a holder which is attached to the gearbox, which is removable in a direction along the second axis line, and which supports the second gear in a rotatable manner with a bearing; and
a second gear shim which is placed at a position between the holder and the gearbox and which can adjust a position of the second gear in the direction along the second axis line, wherein
the second gear shim comprises: a through hole in which the holder is located in a state where the holder penetrates the second gear shim, and a path which extends from an outer circumference edge of the second gear shim to the through hole, wherein the path allows the holder to pass in a direction crossing the second axis line between an outside of the second gear shim and an inside of the through hole.

2. The gear mechanism according to claim 1, wherein
the second gear shim has at least one penetrating hole around the through hole to which a fixing bolt is inserted to fix the holder to the gear box, and
an inner diameter of the penetrating hole is smaller than an outer diameter of a head portion of the fixing bolt.

3. The gear mechanism according to claim 1, wherein the path has a constant width which is equal to or similar to the diameter of the through hole.

4. The gear mechanism according to claim 1 further comprising a first gear shim which can adjust a position of the first gear in a direction along the first axis line, wherein
the first gear shim is preset to have a thickness dimension so that the first gear is arranged within a predetermined range with reference to a design position based on measured dimensional values of components which affect the position of the first gear in the direction along the first axis line.

5. The gear mechanism according to claim 4, wherein the predetermined range is a range of the position of the first gear, the position is configured for achieving an optimal backlash amount between the first gear and the second gear within an adjustable range of the position of the second gear by the second gear shim.

6. The gear mechanism according to claim 4, wherein the first gear shim is set to have a thickness dimension so that the first gear is arranged at a position distant from the second axis line relative to the design position.

7. A robot, comprising:
the gear mechanism according to claim 1.
